(19) United States
(12) Patent Application Publication
(10) Pub. No.: US 2013/0333848 A1
(43) Pub. Date: Dec. 19, 2013

(54) MOTORIZED ROLLER SHADE CONFIGURED FOR LARGER SHADE APPLICATIONS

(71) Applicants: Willis Jay MULLET, Gulf Breeze, FL (US); Richard Scott HAND, Pace, FL (US); Harry Edward ASBURY, Holt, FL (US)

(72) Inventors: Willis Jay MULLET, Gulf Breeze, FL (US); Richard Scott HAND, Pace, FL (US); Harry Edward ASBURY, Holt, FL (US)

(73) Assignee: HOMERUN HOLDINGS CORPORATION, Pensacola, FL (US)

(21) Appl. No.: 13/524,259

(22) Filed: Jun. 15, 2012

(51) Int. Cl. E06B 9/72

(52) U.S. Cl. 160/310

(57) ABSTRACT

A motorized roller shade includes a shade tube, including an outer surface upon which a shade is attached, an inner surface defining an inner cavity and two end portions, and a motor having an output shaft coupled to a support shaft such that the output shaft and the support shaft do not rotate when the support shaft is attached to a mounting bracket. The motorized roller shade further includes a counterbalancing unit configured to provide a counterbalancing force to the shade, a power supply unit, electrically coupled to the motor, configured to supply power to the motor, and an adaption component including at least one of a length adaptation component and a diameter adaptation component arranged within the shade tube and configured to adapt at least one of the motor and the counterbalancing unit to be used with a larger shade tube.

### FIELD OF THE INVENTION

The invention relates to motorized shade components to be used in a number of different size applications. Specifically, the invention relates to motorized shade components configured to be efficiently used in a number of different size applications.

### BACKGROUND OF THE INVENTION

A roller shade is a rectangular panel of fabric, or other material, that is attached to a cylindrical, rotating tube. The shade tube is mounted near the header of a window such that the shade rolls up upon itself as the shade tube rotates in one direction, and rolls down to cover a desired portion of the window when the shade tube is rotated in the opposite direction.

Rotation of the roller shade is accomplished with an electric motor that is coupled to the shade tube. Battery-powered roller shades provide installation flexibility by removing the requirement to connect the motor and control electronics to facility power. The batteries for these roller shades are typically mounted within, above, or adjacent to the shade mounting bracket, headrail or fascia. The motor may be located inside or outside the shade tube, is fixed to the roller shade support and is connected to a simple switch, or, in more sophisticated applications, to a radio frequency (RF) based system that controls the activation of the motor and the rotation of the shade tube. The roller shade typically may include a counter-balance mechanism, such as counter-balance springs, that counter-balances the weight of the shade.

When the roller shade is used for different size applications, then the motor assembly, counter-balance mechanism, and the like must typically be differently sized as well. This complicates manufacture and maintenance and increases costs and parts inventory in order to address all size applications.

Accordingly, there is a need for a shade that can address all size applications without greatly increasing costs and parts inventory and that does not greatly increase manufacturing complexity and maintenance.

### SUMMARY OF THE INVENTION

Aspects of the invention advantageously provide a motorized roller shade that includes a motorized roller shade, including a shade tube, including an outer surface upon which a shade is attached, an inner surface defining an inner cavity and two end portions, a motor having an output shaft coupled to a support shaft such that the output shaft and the support shaft do not rotate when the support shaft is attached to a mounting bracket, a counterbalancing unit configured to provide a counterbalancing force to the shade, a power supply unit, electrically coupled to the motor, configured to supply power to the motor, and an adaption component comprising at least one of a length adaptation component and a diameter adaptation component arranged within the shade tube and configured to adapt at least one of the motor and the counterbalancing unit to be used with a larger shade tube.

Further aspects of the invention advantageously provide a motorized roller shade, including a shade tube, including an outer surface upon which a shade is attached, an inner surface defining an inner cavity and two end portions, a motor having an output shaft configured to rotate the shade tube, a counterbalancing unit configured to provide a counterbalancing force to the shade, a power supply unit, electrically coupled to the motor, configured to supply power to the motor, and an adaption component comprising at least one of a length adaptation component and a diameter adaptation component arranged within the shade tube and configured to adapt at least one of the motor and the counterbalancing unit to be used with a larger shade tube, where at least one of the motor and the counterbalancing unit are configured for use with a smaller shade tube.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 shows a perspective view of a shade assembly constructed in accordance with aspects of the invention.

FIG. 2 shows an opposite perspective view of FIG. 1.

FIG. 3 shows an exploded perspective view of the shade assembly constructed in accordance with aspects of the invention.

FIG. 4 shows an opposite perspective view of FIG. 3.

FIG. 5 shows a perspective view of a roll tube assembly constructed in accordance with aspects of the invention.

FIG. 6 shows an opposite perspective view of FIG. 5.

FIG. 7 shows an exploded perspective view of the roll tube assembly with a motor output shaft extended in accordance with aspects of the invention.

FIG. 8 shows an opposite perspective view of FIG. 7.

FIG. 9 shows a further exploded perspective view of the roll tube assembly with the motor output shaft extended in accordance with aspects of the invention.

FIG. 10 shows an opposite perspective view of FIG. 9.

FIG. 11 shows an exploded perspective view of the roll tube assembly with the counterbalance spring shaft extended in accordance with aspects of the invention.

FIG. 12 shows an opposite perspective view of FIG. 11.

FIG. 13 shows a further exploded perspective view of the roll tube assembly with the counterbalance spring shaft extended in accordance with aspects of the invention.

FIG. 14 shows an opposite perspective view of FIG. 13.

FIG. 15 shows a further exploded perspective view of the roll tube assembly in FIG. 7 with the motor output shaft extended and larger springs added for heavier shades constructed in accordance with aspects of the invention.

FIG. 16 shows an opposite perspective view of FIG. 15.

FIG. 17 shows an extra counterbalancing spring aspect using torsion springs constructed in accordance with aspects of the invention.

### DETAILED DESCRIPTION

The invention will now be described with reference to the drawing figures, in which like reference numerals refer to like parts throughout. The term “shade” as used herein describes any flexible material, such as a shade, a curtain, a screen, etc., that can be deployed from, and retrieved onto, a storage tube or similar structure.

The invention is directed to a motorized roller shade that is suitable for larger and/or commercial applications. In this regard, the roller shade may have taller, heavier, and/or wider shades. The taller, heavier, and/or wider shades may require a larger counterbalance system, such as larger counterbalance springs. The taller, heavier, and/or wider shades may require a larger diameter storage roll. The invention is further directed to an adaptation configuration that allows the use of one or more of a motor, power supply, counterbalance system and the like from smaller shade systems in the larger shade storage tube for the larger application. Being able to use the motor, power supply, counterbalance system, and the like from smaller applications makes manufacture and maintenance easier and decreases costs and parts inventory.

As described in some detail below, the invention provides a motorized roller shade in which batteries, motor, control circuitry, and the like may be entirely contained within a shade tube that may be supported by bearings. Two support shafts may be attached to respective mounting brackets, and the bearings rotatably couple the shade tube to each support shaft. The output shaft of the motor may be fixed to one of the support shafts, while the motor housing is mechanically coupled to the shade tube. Accordingly, operation of the motor causes the motor housing to rotate about the fixed motor output shaft, which causes the shade tube to rotate about the fixed motor output shaft as well. The control circuitry may be operated by the user using a radio frequency remote control. Control signals from the remote control may be received by the control circuitry through an antenna.

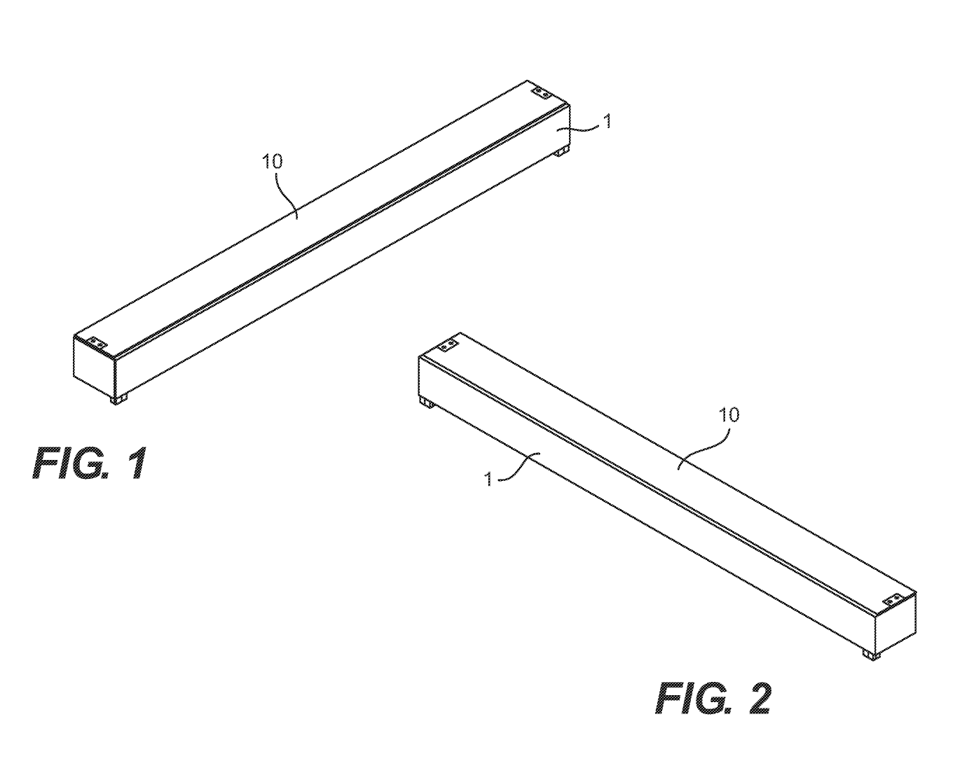

FIG. 1 shows a perspective view of a shade assembly constructed in accordance with aspects of the invention; and FIG. 2 shows an opposite perspective view of FIG. 1. In particular, FIGS. 1 and 2 show a shade assembly, containing the roller shade of the invention that may be mounted above a window or a door either to the inner or outer surface of the structure or into a pocket formed adjacent to the opening. The shade assembly may include a housing 10 and a cover 1.

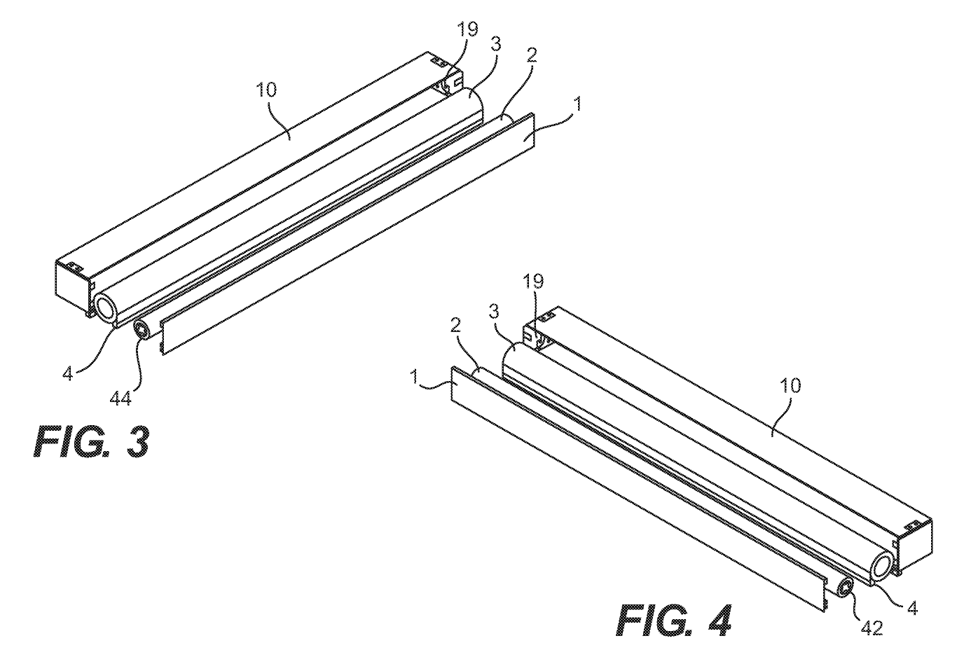

FIG. 3 shows an exploded perspective view of the shade assembly constructed in accordance with aspects of the invention; and FIG. 4 shows an opposite perspective view of FIG. 3. More specifically, FIGS. 3 and 4 show the components of the assembly that may include the housing 10, roller shade material 3 that may include a bottom bar 4, a motorized roll tube 2, end brackets 19, and the cover

The motorized roll tube 2 may be supported by shafts 42, 44 that may be positioned and retained by openings in the end brackets 19. The upper or first end of the shade material 3 may be secured to the motorized roll tube 2 by means known in the art. In some aspects, all of the components necessary to power and control the operation of the motorized roller shade may be advantageously located on or in the motorized roll tube 2.

The motorized roller shade assembly may also include an antenna so that control signals may be received in the motorized roller shade assembly and/or transmitted from the motorized roller shade assembly. The antenna may be arranged anywhere on or in the motorized roller shade assembly.

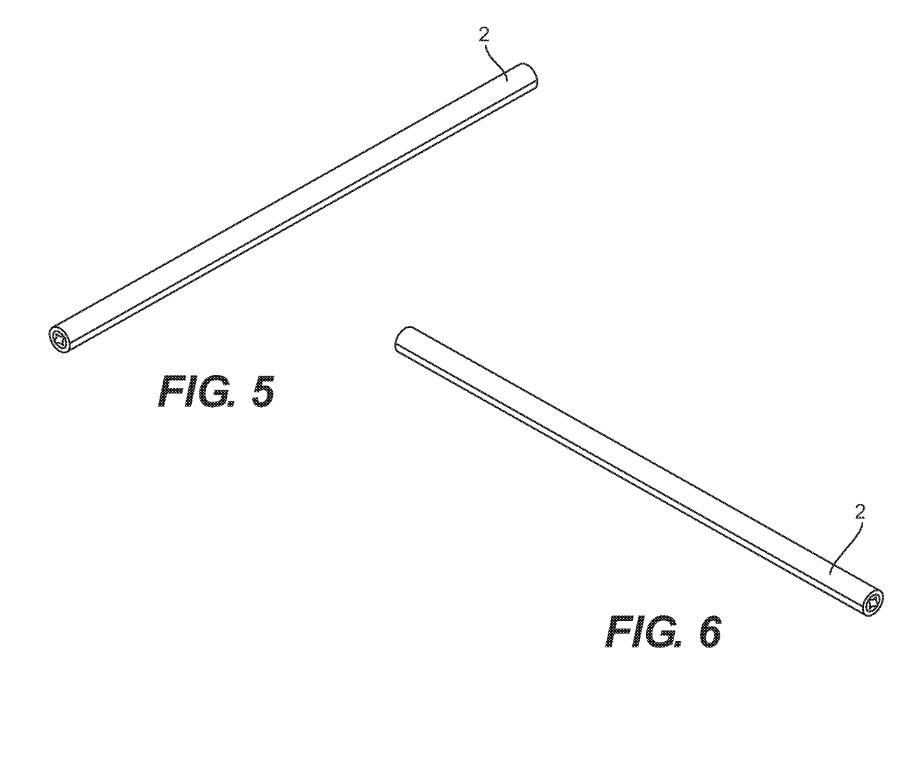

FIG. 5 shows a perspective view of a roll tube assembly constructed in accordance with aspects of the invention; and FIG. 6 shows an opposite perspective view of FIG. 5. In particular, FIGS. 5 and 6 show the details of the roll tube 2 that may be used in conjunction with the invention.

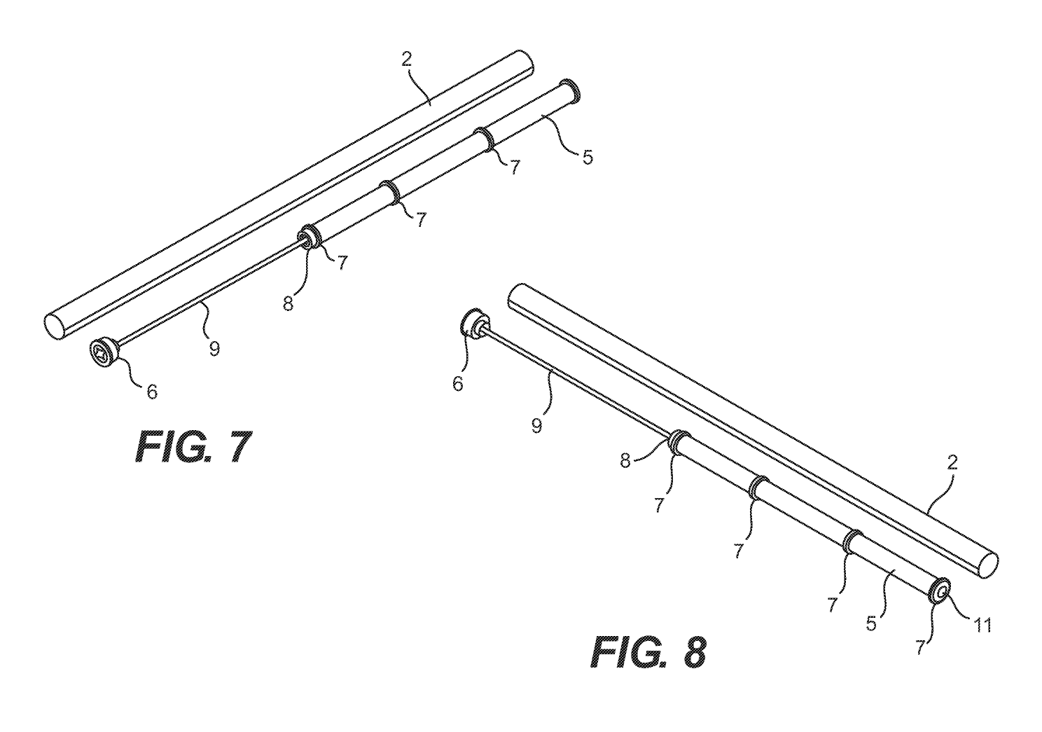

FIG. 7 shows an exploded perspective view of the roll tube assembly with a motor output shaft extended in accordance with aspects of the invention; and FIG. 8 shows an opposite perspective view of FIG. 7. More specifically, FIGS. 7 and 8 show a partial exploded view of the components of the invention that include the outer roll tube 2 that may be sized to resist deflection of heavier shade materials and/or sized to resist deflection due to a greater end to end span. The outer roll tube 2 may have a larger outside diameter that may be greater than 2.25 inches (57 mm) with a preference of 2.50 inches (63.5 mm) in some aspects. However, different shade materials and/or different end to end spans may allow smaller diameters or require greater diameters. FIGS. 7 and 8 further show a motor tube assembly 5 that may include an endcap 8, an end bearing holder 11, and a second end bearing holder 6.

One or more of the motor tube assembly 5, endcap 8, second end bearing holder 6, and end bearing holder 11 may be configured for a smaller roller shade application (smaller diameter, reduced span or length, lighter shade material, and/or the like). In order to implement these components in a larger application, one or more adaptation components are utilized. In particular, the adaptation components may include one or more components to adapt to the larger diameter and/or larger width or span of the roll tube 2 used in the larger application.

In particular, the adaptation components may include one or more components to adapt to the larger diameter of the roll tube 2 in the larger application. The adaptation components may include spacers to hold the motor tube assembly 5 within the outer roll tube 2. The spacers may be implemented as drive spacers 7 shown in FIGS. 7 and 8 that hold the motor tube assembly 5 within the outer roll tube 2 and transmit force from one to the other. However, it is within the scope and spirit to use any functionally equivalent component to hold the motor tube assembly 5 within the outer roll tube 2 and transmit force from one to the other.

Furthermore, the adaptation components may include one or more components to adapt to the larger width or span of the roll tube 2 in the larger application. In this regard, the adaptation components may extend the distance between one or more of the motor tube assembly 5, endcap 8, second end bearing holder 6, and end bearing holder 11 and transmit force from one to the other. As shown in FIGS. 7 and 8, the adaptation components may be an extended output shaft 9 that may connect the motor tube assembly 5 and endcap 8 to the second end bearing holder 6.

Accordingly, the larger length outer shade storage tube 2 with a smaller length motor assembly tube 5 may be placed internal to the outer storage tube 2. The adaptation components, such as the extended output shaft 9 may connect the motor tube assembly 5 and endcap 8 to the second end bearing holder 6. However, it is within the scope and spirit of the invention to use any functional equivalent component.

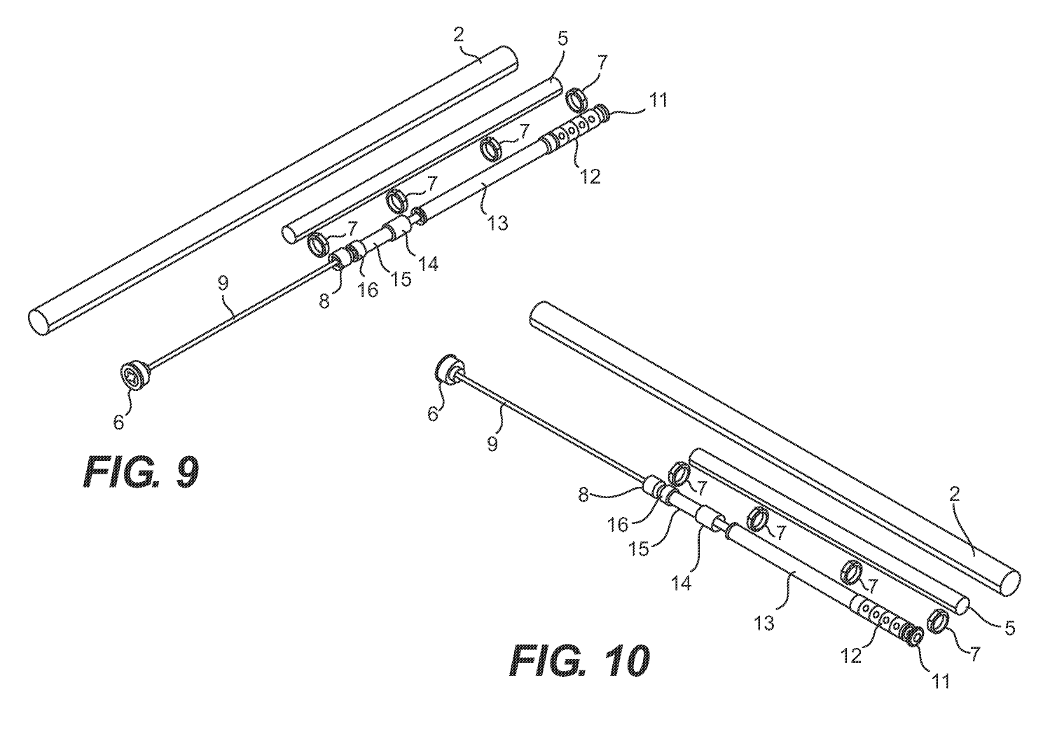

FIG. 9 shows a further exploded perspective view of the roll tube assembly with the motor output shaft extended in accordance with aspects of the invention; and FIG. 10 shows an opposite perspective view of FIG. 9. More specifically, FIGS. 9 and 10 show details of the motor assembly 5. In this regard, the motor assembly 5 may include the end bearing support 8, a motor 15, a drive gear 16, a controller 14, a power supply 13, and the counterbalance springs 12.

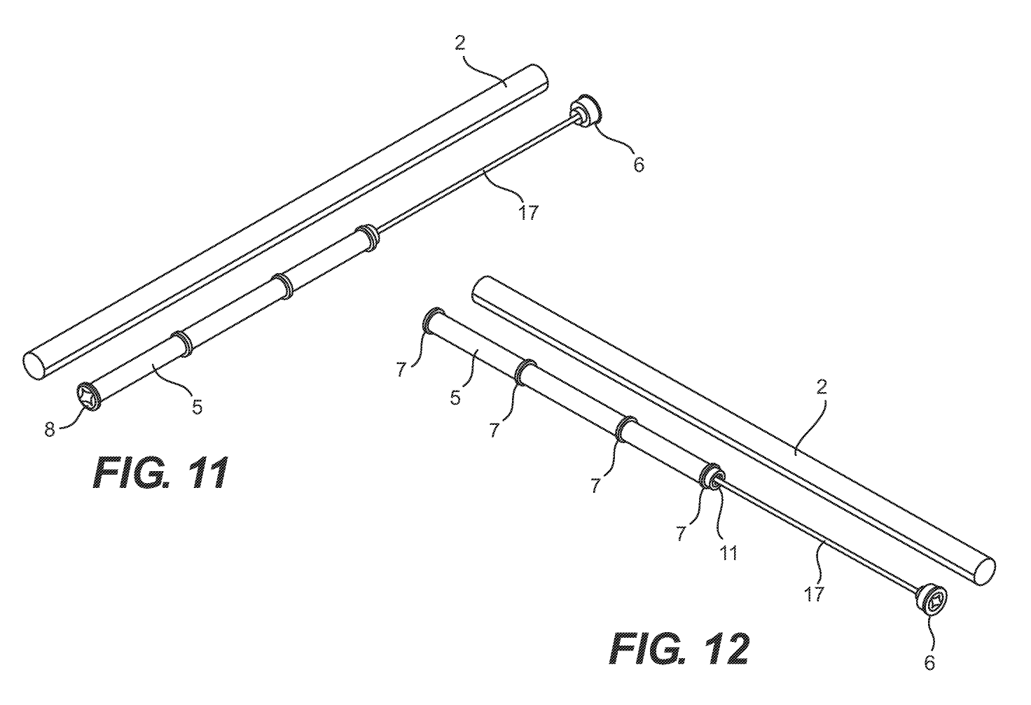

FIG. 11 shows an exploded perspective view of the roll tube assembly with the counterbalance spring shaft extended in accordance with aspects of the invention; and FIG. 12 shows an opposite perspective view of FIG. 11. In particular, FIGS. 11 and 12 show a partial exploded view of the components of this invention including an outer roll tube 2 sized to resist deflection of heavier shade materials and/or sized to resist deflection due to a greater end to end span. The outer roll tube 2 may have a larger outside diameter that may be greater than 2.25 inches (57 mm) with a preference of 2.50 inches (63.5 mm) in some aspects. However, different shade materials and/or different end to end spans may allow smaller diameters or require greater diameters. FIGS. 11 and 12 further show the motor tube assembly 5 with end bearing holders 8 and 11 and a second end bearing holder 6.

Similar to the other aspects described herein, one or more of the motor tube assembly 5, endcap 8, second end bearing holder 6, and end bearing holder 11 may be configured for a smaller roller shade application (smaller diameter, reduced span or length, lighter shade material, and/or the like). In order to implement these components in a larger application, one or more adaptation components must be utilized. In particular, the adaptation components may include one or more components to adapt to the larger diameter and/or larger width or span of the roll tube 2 used in the larger application.

In particular, the adaptation components may include one or more components to adapt to the larger diameter of the roll tube 2 of the larger application. The adaptation components may include spacers to hold the motor tube assembly 5 within the outer roll tube 2 and transmit force from one to the other. The spacers may be implemented as drive spacers 7 as shown in FIGS. 11 and 12 that hold the motor tube assembly 5 within the outer roll tube 2 and transmit force from one to the other. However, it is within the scope and spirit to use any functional equivalent component to hold the motor tube assembly 5 within the outer roll tube 2 and transmit force from one to the other.

Furthermore, the adaptation components may include one or more components to adapt to the larger width or span of the roll tube 2 of the larger application. In this regard, the adaptation components may extend the distance between one or more of the motor tube assembly 5, second end bearing holder 6, and end bearing holder 11 and transmit force from one to the other. As shown in FIGS. 11 and 12 an extended output shaft 17 may connect the motor tube assembly 5 and end bearing holder 11 to the second end bearing holder 6.

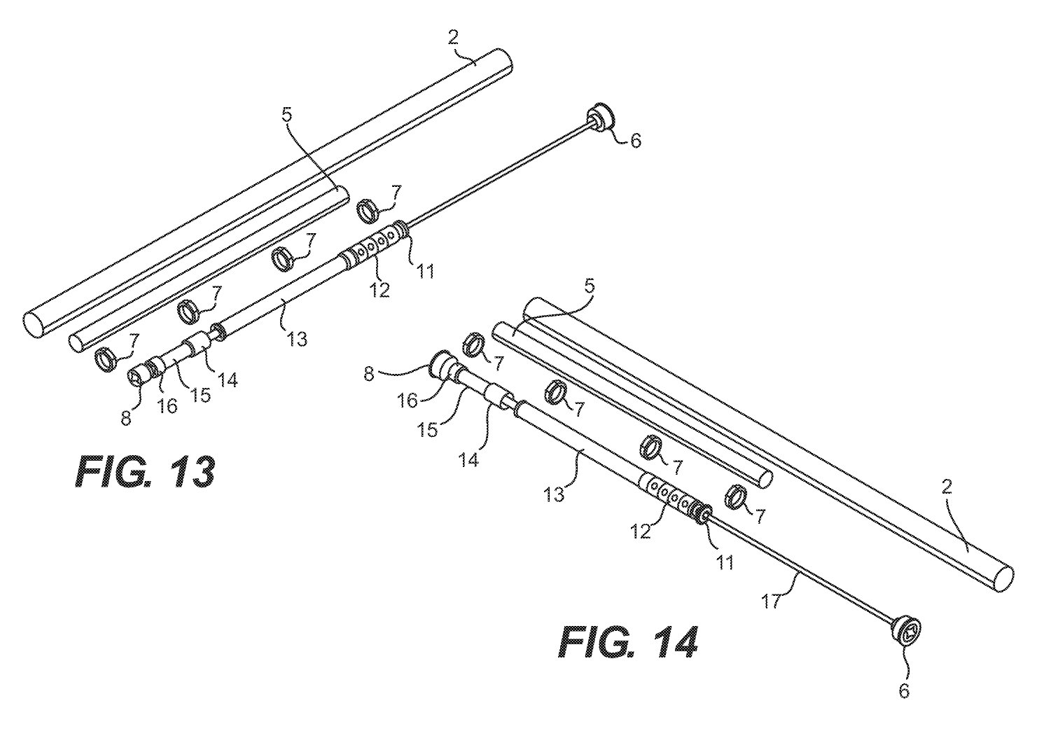

FIG. 13 shows a further exploded perspective view of the roll tube assembly with the counterbalance spring shaft extended in accordance with aspects of the invention; and FIG. 14 shows an opposite perspective view of FIG. 13.

FIGS. 13 and 14 show a further exploded view of the motor assembly 5 including the end bearing support 8, the motor 15, the drive gear 16, the controller 14, the power supply 13, the counterbalance springs 12, the bearing holders 6 and 8, the drive spacers 7, and the extended spring shaft 17.

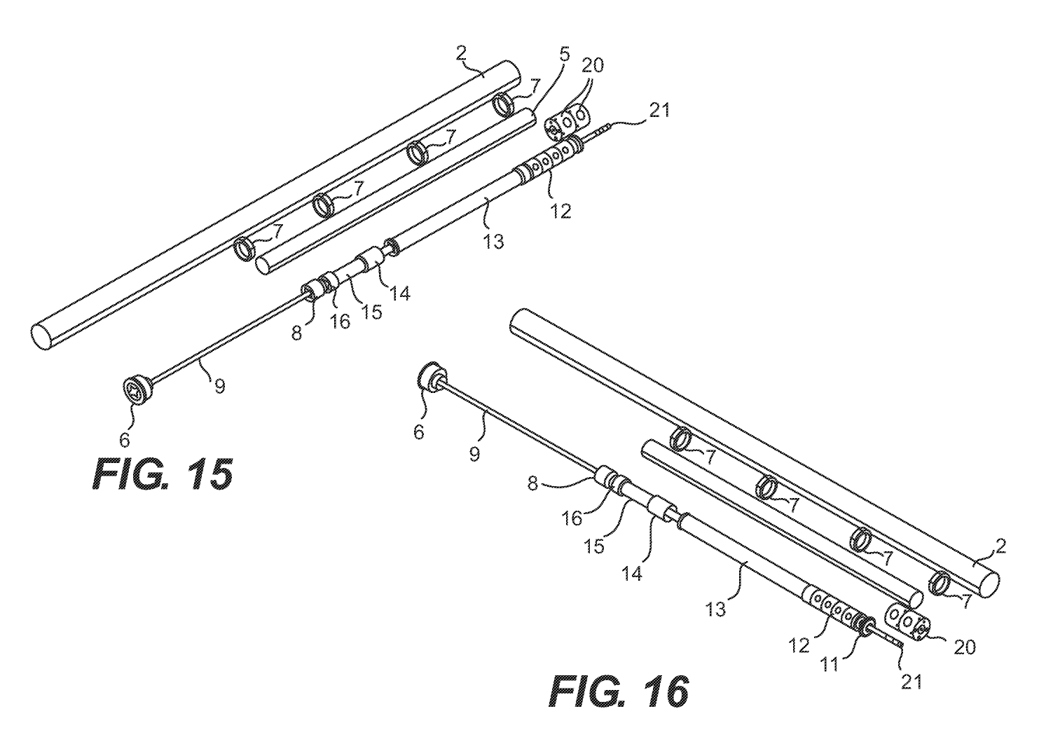

FIG. 15 shows a further exploded perspective view of the roll tube assembly in FIG. 7 with the motor output shaft extended and larger springs added for heavier shades constructed in accordance with aspects of the invention; and FIG. 16 shows an opposite perspective view of FIG. 15. In particular, FIGS. 15 and 16 show all the components of FIGS. 7 and 8. However, FIG. 15 includes the use of additional larger counter balance springs 20 and an enlarged extended spring shaft 21 to accommodate the counterbalancing of larger and heavier shades and blinds. It should be noted that additional larger counter balance springs 20 and enlarged extended spring shaft 21 may be arranged anywhere within the roller shade system.

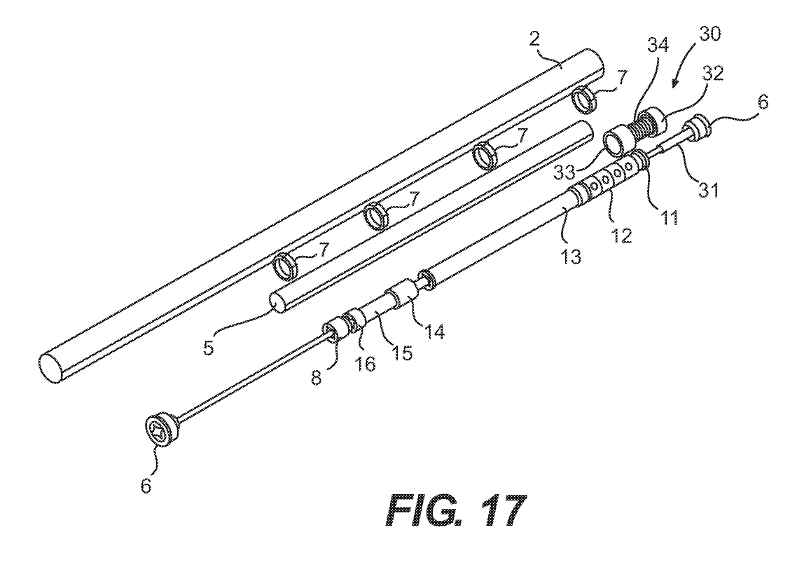

FIG. 17 shows a second extra counterbalancing spring aspect using torsion springs constructed in accordance with aspects of the invention. In this regard, although any type of biasing member can be used for the additional counterbalancing, the counterbalance aspect shown in FIG. 17 uses a torsion spring assembly 30. This aspect may include a stationary perch 32 that may be secured from rotation by a hex shaft 31. This aspect may further include a dynamic perch 33 that may be turned by the tube 2 and the torsion spring 34. In general, the torsion springs may be added in the larger tube 2 application to the existing power springs used in the smaller tube application to achieve proper counterbalance. As with all aspects of the invention, the counterbalance springs provide a rotational force to assist the shade being rolled up. The counterbalance springs are wound when the shade rolled down.

Accordingly, the shade of the invention as described above in the various exemplary aspects associated with the drawings and broader applications described above can address many size applications without greatly increasing costs and parts inventory and not greatly increasing manufacturing complexity and maintenance.

The motorized roller shade assembly may include other components such as an electrical power connector that includes a terminal that couples to a power supply unit, and power cables that may connect to the circuit board(s) located within the circuit board housing.

In some aspects, two circuit boards may be mounted within the circuit board housing in an orthogonal relationship. Circuit boards generally include all of the supporting circuitry and electronic components necessary to sense and control the operation of the motor, manage and/or condition the power provided by the power supply unit, etc., including, for example, a controller or microcontroller, memory, a wireless receiver, etc. In one embodiment, the microcontroller is a Microchip 8-bit microcontroller, such as the PIC18F25K20, while the wireless receiver is a Micrel QwikRadio® receiver, such as the MICRF219. The microcontroller may be coupled to the wireless receiver using a local processor bus, a serial bus, a serial peripheral interface, etc. In another embodiment, the wireless receiver and microcontroller may be integrated into a single chip, such as, for example, the Zensys ZW0201 Z-Wave Single Chip, etc. In another embodiment, a wireless transmitter is also provided, and information relating to the status, performance, etc., of the motorized roller shade may be transmitted periodically to a wireless diagnostic device, or, preferably, in response to a specific query from the wireless diagnostic device.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A motorized roller shade, comprising:
a shade tube, including an outer surface upon which a shade is attached, an inner surface defining an inner cavity and two end portions;
a motor having an output shaft coupled to a support shaft such that the output shaft and the support shaft do not rotate when the support shaft is attached to a mounting bracket;
a counterbalancing unit configured to provide a counterbalancing force to the shade;
a power supply unit, electrically coupled to the motor, configured to supply power to the motor; and
an adaption component comprising at least one of a length adaptation component and a diameter adaptation component arranged within the shade tube and configured to adapt at least one of the motor and the counterbalancing unit to be used with a larger shade tube.

2. The motorized roller shade according to claim 1 wherein the adaption component comprises the length adaptation component and the length adaptation component comprises a shaft extending between the motor and one of the two end portions.

3. The motorized roller shade according to claim 1 wherein the adaption component comprises the length adaptation component and the length adaptation component comprises a shaft extending between the counterbalancing unit and one of the two end portions.

4. The motorized roller shade according to claim 1 wherein the adaption component comprises the diameter adaptation component and the diameter adaptation component comprises a spacer arranged between the motor and the shade tube.

5. The motorized roller shade according to claim 4 wherein the spacer comprises a drive spacer that transmits force from the motor to the roll tube.

6. The motorized roller shade according to claim 1 wherein the adaption component comprises the length adaptation component and the length adaptation component comprises a shaft extending between one of the motor and the counterbalancing unit, and one of the two end portions; and
the adaption component further comprises the diameter adaptation component and the diameter adaptation component comprises a spacer arranged between the motor and the shade tube.

7. The motorized roller shade according to claim 1 wherein the end portions comprise bearing holders.

8. The motorized roller shade according to claim 1 wherein the motor further comprises a motor tube assembly.

9. The motorized roller shade according to claim 1 wherein the counterbalancing unit comprises a plurality of spring devices.

10. The motorized roller shade according to claim 1 further comprising at least one of a drive gear, a controller, and a power supply.

11. A motorized roller shade, comprising:
a shade tube, including an outer surface upon which a shade is attached, an inner surface defining an inner cavity and two end portions;
a motor having an output shaft configured to rotate the shade tube;
a counterbalancing unit configured to provide a counterbalancing force to the shade;
a power supply unit, electrically coupled to the motor, configured to supply power to the motor; and
an adaption component comprising at least one of a length adaptation component and a diameter adaptation component arranged within the shade tube and configured to adapt at least one of the motor and the counterbalancing unit to be used with a larger shade tube,
wherein at least one of the motor and the counterbalancing unit are configured for use with a smaller shade tube.

12. The motorized roller shade according to claim 1 wherein the adaption component comprises the length adaptation component and the length adaptation component comprises a shaft extending between the motor and one of the two end portions.

13. The motorized roller shade according to claim 1 wherein the adaption component comprises the length adaptation component and the length adaptation component comprises a shaft extending between the counterbalancing unit and one of the two end portions.

14. The motorized roller shade according to claim 1 wherein the adaption component comprises the diameter adaptation component and the diameter adaptation component comprises a spacer arranged between the motor and the shade tube.

15. The motorized roller shade according to claim 1 wherein the adaption component comprises the length adaptation component and the length adaptation component comprises a shaft extending between one of the motor and the counterbalancing unit, and one of the two end portions; and
the adaption component further comprises the diameter adaptation component and the diameter adaptation component comprises a spacer arranged between the motor and the shade tube.

16. The motorized roller shade according to claim 1 wherein the end portions comprise bearing holders.

17. The motorized roller shade according to claim 1 wherein the motor further comprises a motor tube assembly.

18. The motorized roller shade according to claim 1 wherein the counterbalancing unit comprises a plurality of spring devices.

19. The motorized roller shade according to claim 1 further comprising at least one of a drive gear, a controller, and a power supply.

20. The motorized roller shade according to claim 14 wherein the spacer comprises a drive spacer that transmits force from the motor to the roll tube.
